(19) United States
(12) Patent Application Publication
(10) Pub. No.: US 2025/0265303 A1
(43) Pub. Date: Aug. 21, 2025

(54) SYSTEM AND METHOD FOR AUTOMATIC SUMMARY GENERATION

(71) Applicant: Yahoo Assets LLC, New York, NY (US)

(72) Inventors: Liuqing Li, Santa Clara, CA (US); Xinyue Wang, Santa Clara, CA (US); Donghyun Kim, San Jose, CA (US); Rao Shen, Sunnyvale, CA (US); Seung Byum Seo, Champaign, IL (US); Hang Su, Vienna, VA (US)

(21) Appl. No.: 18/442,144

(22) Filed: Feb. 15, 2024

(51) Int. Cl. G06F 16/957; G06F 16/9538; G06F 40/40

(52) U.S. Cl. CPC G06F 16/9577; G06F 16/9538; G06F 40/40

(57) ABSTRACT

In accordance with the present disclosure, one or more computing devices and/or methods are provided. In an example, a query may be received from a client device. In response to the query, a plurality of search results corresponding to a plurality of internet resources associated with the query may be generated. A plurality of content items may be generated based upon the plurality of search results. The plurality of content items may be generated using a plurality of content extraction tools. A language model may be used to generate a plurality of summaries of the plurality of content items. Summary scores of the plurality of summaries may be determined. A first summary may be selected from the plurality of summaries based upon the summary scores. In response to selecting the first summary, the first summary may be provided for display on the client device.

### BACKGROUND

Many services, such as websites, applications, etc. may provide platforms for navigating through various media items. For example, a user may interact with a search interface to find search results for a query.

### SUMMARY

In accordance with the present disclosure, one or more computing devices and/or methods are provided. In an example, a query may be received from a client device. In response to the query, a plurality of search results corresponding to a plurality of internet resources associated with the query may be generated. A first content extraction model may be used to generate a first content item based upon a first search result of the plurality of search results. A second content extraction model may be used to generate a second content item based upon the first search result. The first content extraction model may be used to generate a third content item based upon a second search result of the plurality of search results. The second content extraction model may be used to generate a fourth content item based upon the second search result. A language model may be used to generate a plurality of summaries. The plurality of summaries may comprise a first summary of the first content item, a second summary of the second content item, a third summary of the third content item and/or a fourth summary of the fourth content item. Summary scores of the plurality of summaries may be determined. The first summary may be selected from the plurality of summaries based upon the summary scores. In response to selecting the first summary, the first summary may be provided for display on the client device

### DESCRIPTION OF THE DRAWINGS

While the techniques presented herein may be embodied in alternative forms, the particular embodiments illustrated in the drawings are only a few examples that are supplemental of the description provided herein. These embodiments are not to be interpreted in a limiting manner, such as limiting the claims appended hereto.

FIG. 1 is an illustration of a scenario involving various examples of networks that may connect servers and clients.

FIG. 2 is an illustration of a scenario involving an example configuration of a server that may utilize and/or implement at least a portion of the techniques presented herein.

FIG. 3 is an illustration of a scenario involving an example configuration of a client that may utilize and/or implement at least a portion of the techniques presented herein.

FIG. 4 is a flow chart illustrating an example method for providing summaries in response to queries.

FIG. 5A is a component block diagram illustrating an example system for providing summaries in response to queries, where a search interface is displayed on a first client device.

FIG. 5B is a component block diagram illustrating an example system for providing summaries in response to queries, where content items are generated based upon search results.

FIG. 5C is a component block diagram illustrating an example system for providing summaries in response to queries, where a content extraction tool is used to generate a content item based upon internet resource data associated with a search result.

FIG. 5D is a component block diagram illustrating an example system for providing summaries in response to queries, where summaries are generated based upon content items.

FIG. 5E is a component block diagram illustrating an example system for providing summaries in response to queries, where a language model is used to generate a summary based upon a content item.

FIG. 5F is a component block diagram illustrating an example system for providing summaries in response to queries, where a search interface displays a summary and/or list of search results in response to a query.

FIG. 6 is a component block diagram illustrating an example system comprising a generative artificial intelligence (AI) pipeline for providing summaries in response to queries.

FIG. 7 is an illustration of a scenario featuring an example non-transitory machine readable medium in accordance with one or more of the provisions set forth herein.

### DETAILED DESCRIPTION

Subject matter will now be described more fully hereinafter with reference to the accompanying drawings, which form a part hereof, and which show, by way of illustration, specific example embodiments. This description is not intended as an extensive or detailed discussion of known concepts. Details that are known generally to those of ordinary skill in the relevant art may have been omitted, or may be handled in summary fashion.

The following subject matter may be embodied in a variety of different forms, such as methods, devices, components, and/or systems. Accordingly, this subject matter is not intended to be construed as limited to any example embodiments set forth herein. Rather, example embodiments are provided merely to be illustrative. Such embodiments may, for example, take the form of hardware, software, firmware or any combination thereof.

### 1. Computing Scenario

The following provides a discussion of some types of computing scenarios in which the disclosed subject matter may be utilized and/or implemented.

### 1.1. Networking

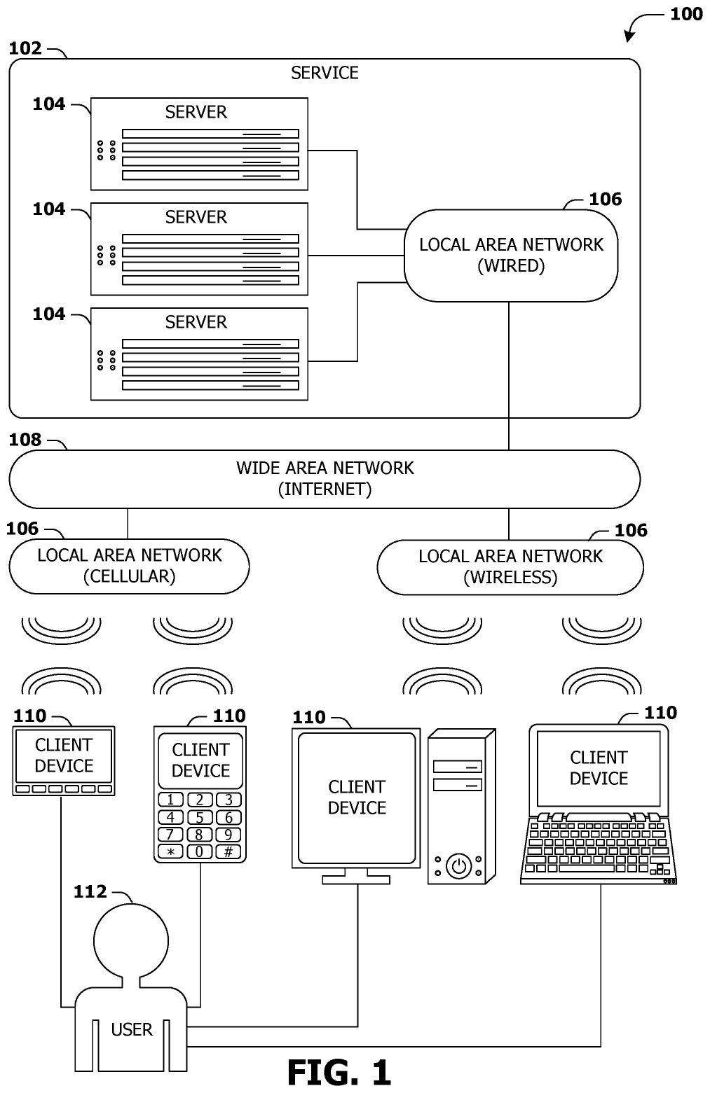

FIG. 1 is an interaction diagram of a scenario 100 illustrating a service 102 provided by a set of servers 104 to a set of client devices 110 via various types of networks. The servers 104 and/or client devices 110 may be capable of transmitting, receiving, processing, and/or storing many types of signals, such as in memory as physical memory states.

The servers 104 of the service 102 may be internally connected via a local area network 106 (LAN), such as a wired network where network adapters on the respective servers 104 are interconnected via cables (e.g., coaxial and/or fiber optic cabling), and may be connected in various topologies (e.g., buses, token rings, meshes, and/or trees). The servers 104 may be interconnected directly, or through one or more other networking devices, such as routers, switches, and/or repeaters. The servers 104 may utilize a variety of physical networking protocols (e.g., Ethernet and/or Fiber Channel) and/or logical networking protocols (e.g., variants of an Internet Protocol (IP), a Transmission Control Protocol (TCP), and/or a User Datagram Protocol (UDP). The local area network 106 may include, e.g., analog telephone lines, such as a twisted wire pair, a coaxial cable, full or fractional digital lines including T1, T2, T3, or T4 type lines, Integrated Services Digital Networks (ISDNs), Digital Subscriber Lines (DSLs), wireless links including satellite links, or other communication links or channels, such as may be known to those skilled in the art. The local area network 106 may be organized according to one or more network architectures, such as server/client, peer-to-peer, and/or mesh architectures, and/or a variety of roles, such as administrative servers, authentication servers, security monitor servers, data stores for objects such as files and databases, business logic servers, time synchronization servers, and/or front-end servers providing a user-facing interface for the service 102.

Likewise, the local area network 106 may comprise one or more sub-networks, such as may employ differing architectures, may be compliant or compatible with differing protocols and/or may interoperate within the local area network 106. Additionally, a variety of local area networks 106 may be interconnected; e.g., a router may provide a link between otherwise separate and independent local area networks 106.

In the scenario 100 of FIG. 1, the local area network 106 of the service 102 is connected to a wide area network 108 (WAN) that allows the service 102 to exchange data with other services 102 and/or client devices 110. The wide area network 108 may encompass various combinations of devices with varying levels of distribution and exposure, such as a public wide-area network (e.g., the Internet) and/or a private network (e.g., a virtual private network (VPN) of a distributed enterprise).

In the scenario 100 of FIG. 1, the service 102 may be accessed via the wide area network 108 by a user 112 of one or more client devices 110, such as a portable media player (e.g., an electronic text reader, an audio device, or a portable gaming, exercise, or navigation device); a portable communication device (e.g., a camera, a phone, a wearable or a text chatting device); a workstation; and/or a laptop form factor computer. The respective client devices 110 may communicate with the service 102 via various connections to the wide area network 108. As a first such example, one or more client devices 110 may comprise a cellular communicator and may communicate with the service 102 by connecting to the wide area network 108 via a wireless local area network 106 provided by a cellular provider. As a second such example, one or more client devices 110 may communicate with the service 102 by connecting to the wide area network 108 via a wireless local area network 106 (and/or via a wired network) provided by a location such as the user's home or workplace (e.g., a WiFi (Institute of Electrical and Electronics Engineers (IEEE) Standard 802.11) network or a Bluetooth (IEEE Standard 802.15.1) personal area network). In this manner, the servers 104 and the client devices 110 may communicate over various types of networks. Other types of networks that may be accessed by the servers 104 and/or client devices 110 include mass storage, such as network attached storage (NAS), a storage area network (SAN), or other forms of computer or machine readable media.

### 1.2. Server Configuration

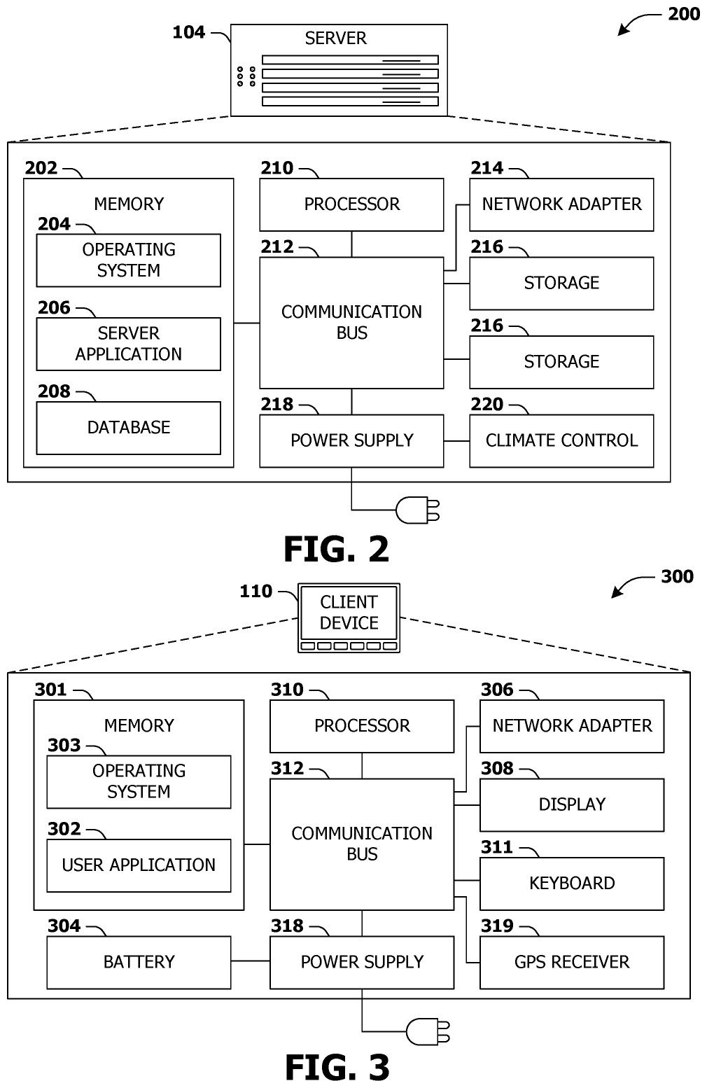

FIG. 2 presents a schematic architecture diagram 200 of a server 104 that may utilize at least a portion of the techniques provided herein. Such a server 104 may vary widely in configuration or capabilities, alone or in conjunction with other servers, in order to provide a service such as the service 102.

The server 104 may comprise one or more processors 210 that process instructions. The one or more processors 210 may optionally include a plurality of cores; one or more coprocessors, such as a mathematics coprocessor or an integrated graphical processing unit (GPU); and/or one or more layers of local cache memory. The server 104 may comprise memory 202 storing various forms of applications, such as an operating system 204; one or more server applications 206, such as a hypertext transport protocol (HTTP) server, a file transfer protocol (FTP) server, or a simple mail transport protocol (SMTP) server; and/or various forms of data, such as a database 208 or a file system. The server 104 may comprise a variety of peripheral components, such as a wired and/or wireless network adapter 214 connectible to a local area network and/or wide area network; one or more storage components 216, such as a hard disk drive, a solid-state storage device (SSD), a flash memory device, and/or a magnetic and/or optical disk reader.

The server 104 may comprise a mainboard featuring one or more communication buses 212 that interconnect the processor 210, the memory 202, and various peripherals, using a variety of bus technologies, such as a variant of a serial or parallel AT Attachment (ATA) bus protocol; a Uniform Serial Bus (USB) protocol; and/or Small Computer System Interface (SCI) bus protocol. In a multibus scenario, a communication bus 212 may interconnect the server 104 with at least one other server. Other components that may optionally be included with the server 104 (though not shown in the schematic diagram 200 of FIG. 2) include a display; a display adapter, such as a graphical processing unit (GPU); input peripherals, such as a keyboard and/or mouse; and a flash memory device that may store a basic input/output system (BIOS) routine that facilitates booting the server 104 to a state of readiness.

The server 104 may operate in various physical enclosures, such as a desktop or tower, and/or may be integrated with a display as an “all-in-one” device. The server 104 may be mounted horizontally and/or in a cabinet or rack, and/or may simply comprise an interconnected set of components. The server 104 may comprise a dedicated and/or shared power supply 218 that supplies and/or regulates power for the other components. The server 104 may provide power to and/or receive power from another server and/or other devices. The server 104 may comprise a shared and/or dedicated climate control unit 220 that regulates climate properties, such as temperature, humidity, and/or airflow. Many such servers 104 may be configured and/or adapted to utilize at least a portion of the techniques presented herein.

### 1.3. Client Device Configuration

FIG. 3 presents a schematic architecture diagram 300 of a client device 110 whereupon at least a portion of the techniques presented herein may be implemented. Such a client device 110 may vary widely in configuration or capabilities, in order to provide a variety of functionality to a user such as the user 112. The client device 110 may be provided in a variety of form factors, such as a desktop or tower workstation; an “all-in-one” device integrated with a display 308; a laptop, tablet, convertible tablet, or palmtop device; a wearable device mountable in a headset, eyeglass, earpiece, and/or wristwatch, and/or integrated with an article of clothing; and/or a component of a piece of furniture, such as a tabletop, and/or of another device, such as a vehicle or residence. The client device 110 may serve the user in a variety of roles, such as a workstation, kiosk, media player, gaming device, and/or appliance.

The client device 110 may comprise one or more processors 310 that process instructions. The one or more processors 310 may optionally include a plurality of cores; one or more coprocessors, such as a mathematics coprocessor or an integrated graphical processing unit (GPU); and/or one or more layers of local cache memory. The client device 110 may comprise memory 301 storing various forms of applications, such as an operating system 303; one or more user applications 302, such as document applications, media applications, file and/or data access applications, communication applications such as web browsers and/or email clients, utilities, and/or games; and/or drivers for various peripherals. The client device 110 may comprise a variety of peripheral components, such as a wired and/or wireless network adapter 306 connectible to a local area network and/or wide area network; one or more output components, such as a display 308 coupled with a display adapter (optionally including a graphical processing unit (GPU)), a sound adapter coupled with a speaker, and/or a printer; input devices for receiving input from the user, such as a keyboard 311, a mouse, a microphone, a camera, and/or a touch-sensitive component of the display 308; and/or environmental sensors, such as a global positioning system (GPS) receiver 319 that detects the location, velocity, and/or acceleration of the client device 110, a compass, accelerometer, and/or gyroscope that detects a physical orientation of the client device 110. Other components that may optionally be included with the client device 110 (though not shown in the schematic architecture diagram 300 of FIG. 3) include one or more storage components, such as a hard disk drive, a solid-state storage device (SSD), a flash memory device, and/or a magnetic and/or optical disk reader; and/or a flash memory device that may store a basic input/output system (BIOS) routine that facilitates booting the client device 110 to a state of readiness; and a climate control unit that regulates climate properties, such as temperature, humidity, and airflow.

The client device 110 may comprise a mainboard featuring one or more communication buses 312 that interconnect the processor 310, the memory 301, and various peripherals, using a variety of bus technologies, such as a variant of a serial or parallel AT Attachment (ATA) bus protocol; the Uniform Serial Bus (USB) protocol; and/or the Small Computer System Interface (SCI) bus protocol. The client device 110 may comprise a dedicated and/or shared power supply 318 that supplies and/or regulates power for other components, and/or a battery 304 that stores power for use while the client device 110 is not connected to a power source via the power supply 318. The client device 110 may provide power to and/or receive power from other client devices.

In some scenarios, as a user 112 interacts with a software application on a client device 110 (e.g., an instant messenger and/or electronic mail application), descriptive content in the form of signals or stored physical states within memory (e.g., an email address, instant messenger identifier, phone number, postal address, message content, date, and/or time) may be identified. Descriptive content may be stored, typically along with contextual content. For example, the source of a phone number (e.g., a communication received from another user via an instant messenger application) may be stored as contextual content associated with the phone number. Contextual content, therefore, may identify circumstances surrounding receipt of a phone number (e.g., the date or time that the phone number was received), and may be associated with descriptive content. Contextual content, may, for example, be used to subsequently search for associated descriptive content. For example, a search for phone numbers received from specific individuals, received via an instant messenger application or at a given date or time, may be initiated. The client device 110 may include one or more servers that may locally serve the client device 110 and/or other client devices of the user 112 and/or other individuals. For example, a locally installed webserver may provide web content in response to locally submitted web requests. Many such client devices 110 may be configured and/or adapted to utilize at least a portion of the techniques presented herein.

### 2. Presented Techniques

One or more computing devices and/or techniques for automatically generating and/or providing summaries in response to queries are provided. For example, a content system may receive a query from a client device. In response to the query, the content system may generate a plurality of search results corresponding to a plurality of internet resources associated with the query. The content system may generate a plurality of content items based upon the plurality of search results. A language model may be used to generate candidate summaries of the plurality of content items. Summary scores of the plurality of summaries may be determined. A first summary may be selected from the plurality of summaries based upon the summary scores. In response to selecting the first summary, the first summary may be provided for display on the client device.

In some examples, the plurality of content items may be generated using a plurality of content extraction tools, which may provide for enhanced diversity of the candidate summaries (and thereby increased likelihood that the candidate summaries include higher quality summaries from which to select the first summary to present to the client device, for example). Alternatively and/or additionally, the content system may implement a relevance check (e.g., a question answer check) that may check relevance statuses of each summary at item level (e.g., the relevance check may ensure that each summary item is relevant to the query and/or ensure that each summary item comprises a relevant and/or correct answer to a question and/or request posed by the query), thereby providing for improved quality of the resulting summary provided to the client device. Alternatively and/or additionally, the present disclosure may provide for improved quality and/or reduced logic issues (for questions that require ordered instructions and/or tasks, for example), such as due, at least in part, to the content system generating a candidate summary based upon content from a single internet resource of a single search result such that correct logic and/or flow (e.g., correct ordering of instructions and/or tasks listed in the candidate summary and/or reduced redundancies between summary items) is maintained in the candidate summary.

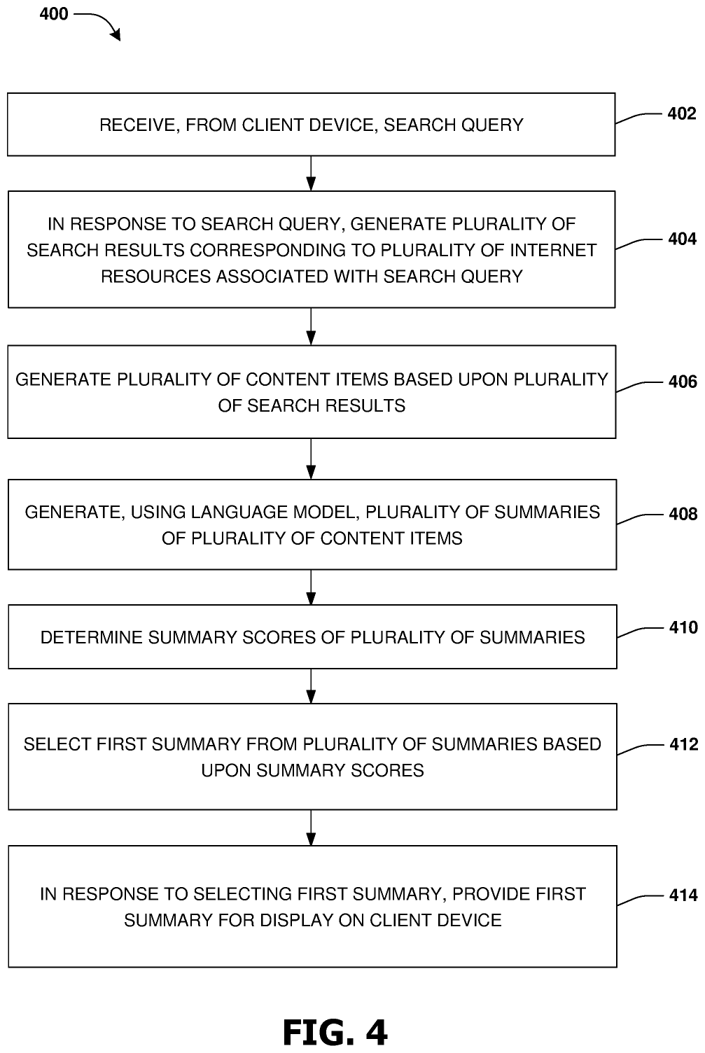

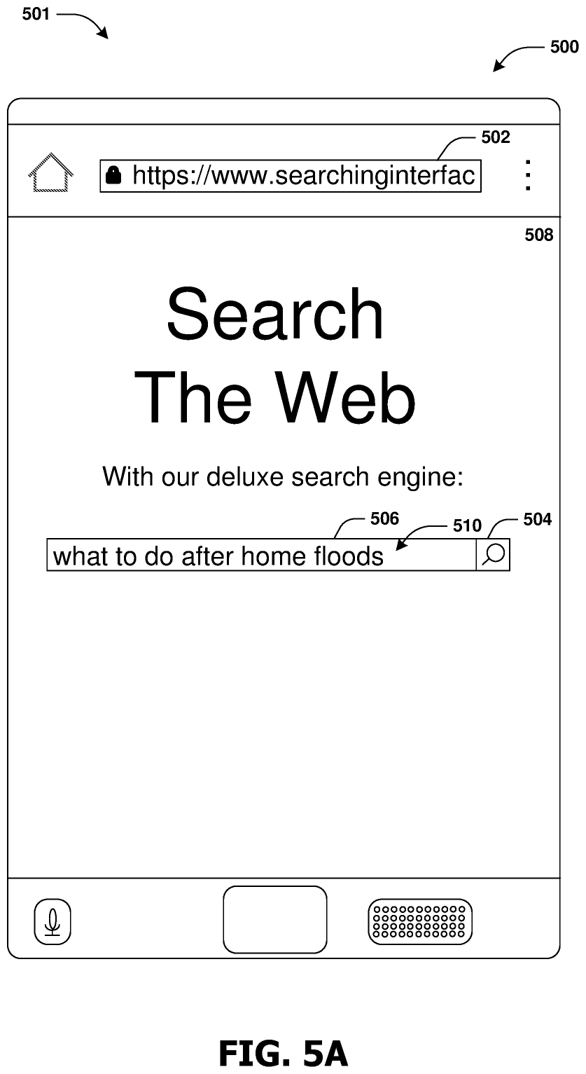

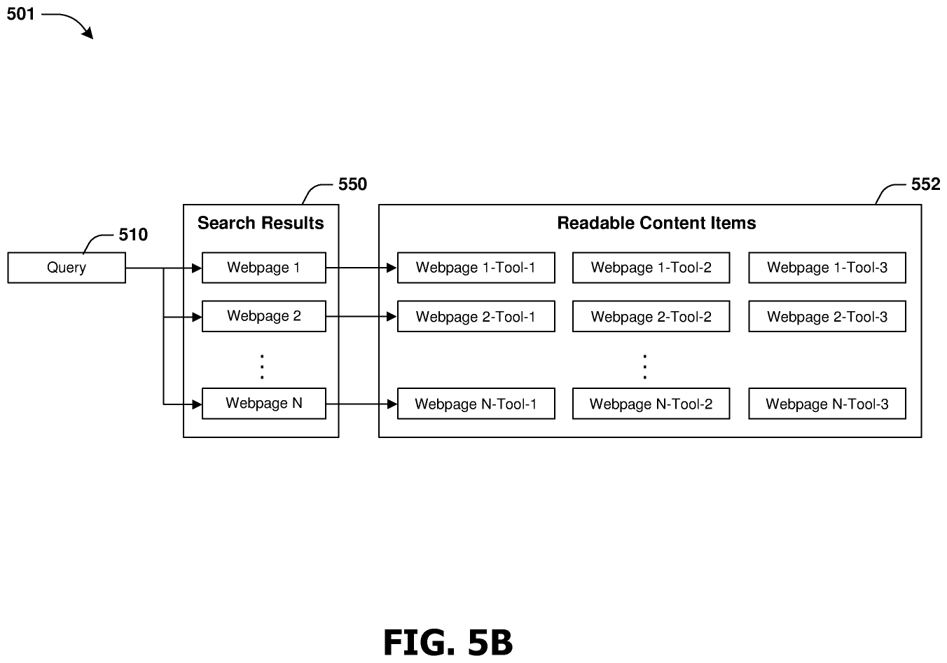

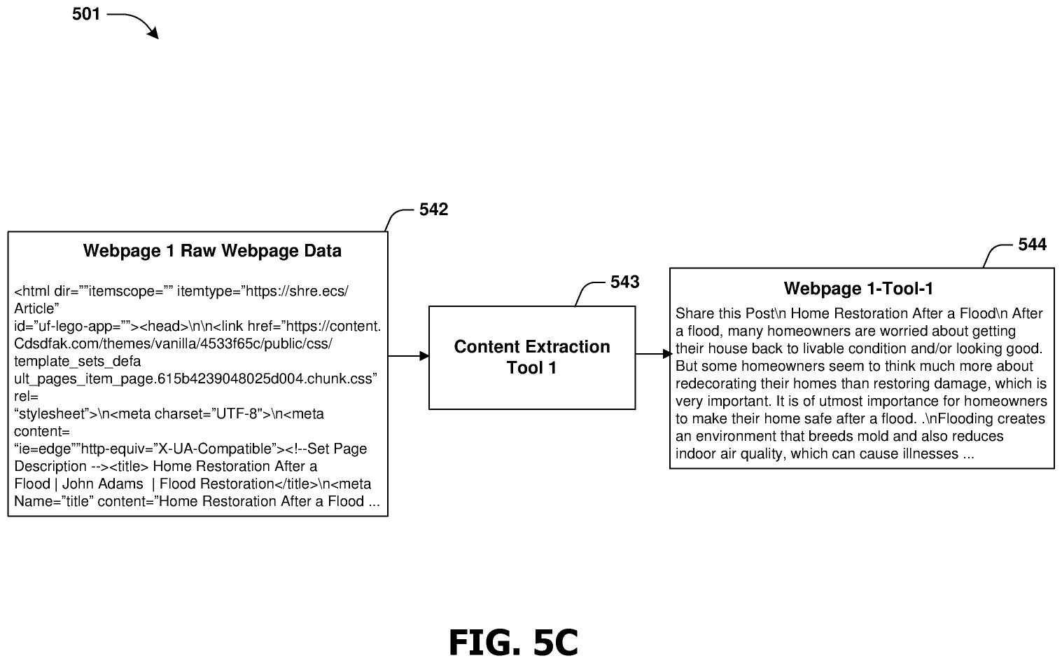

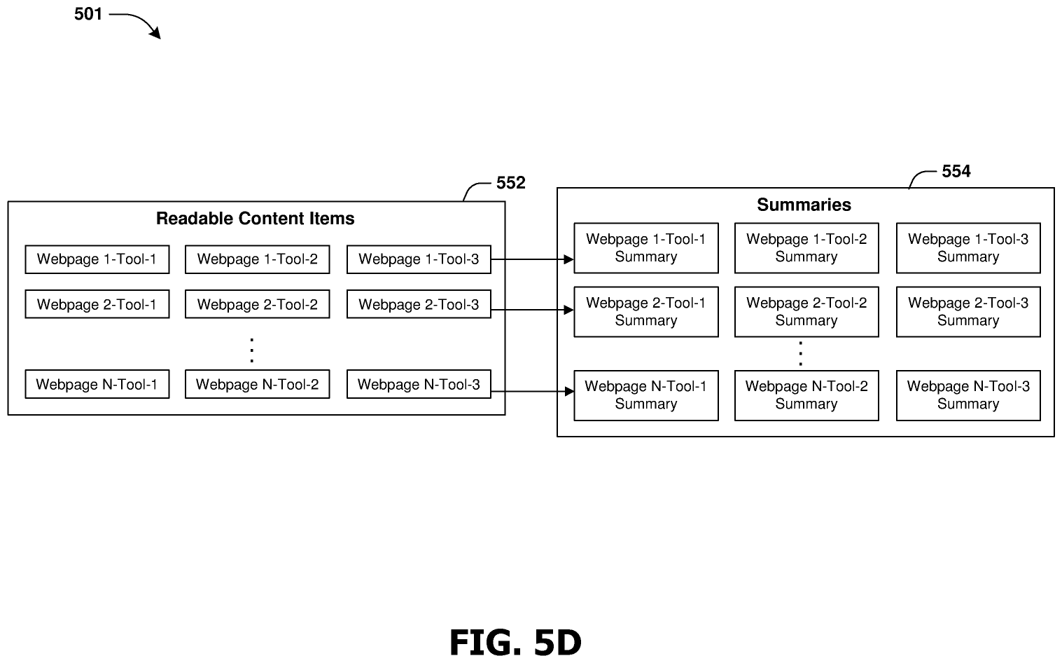

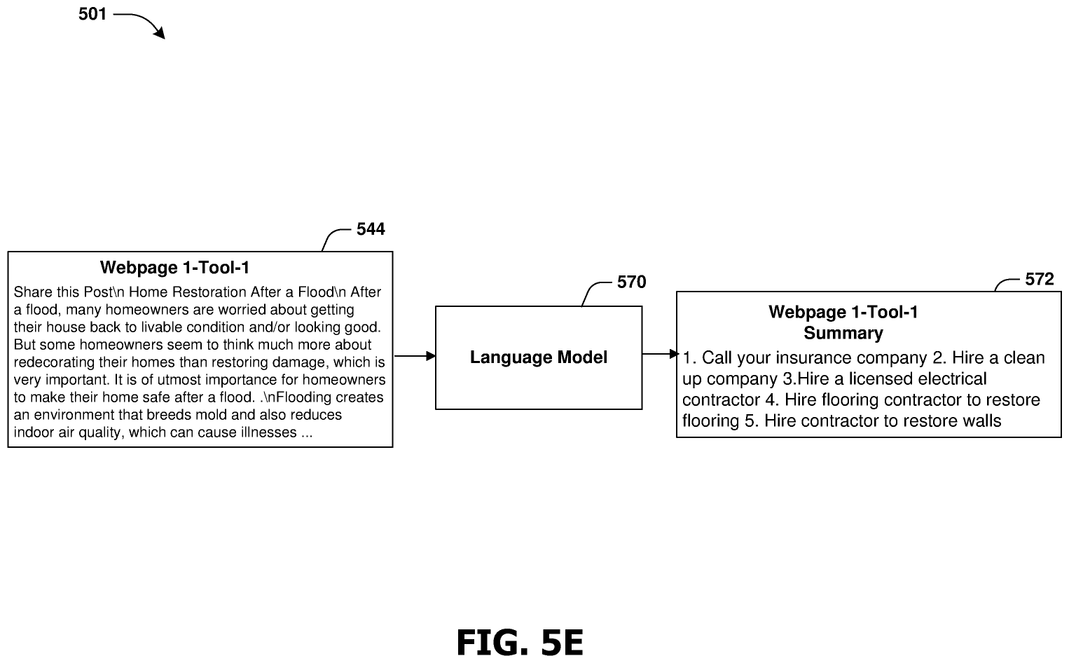

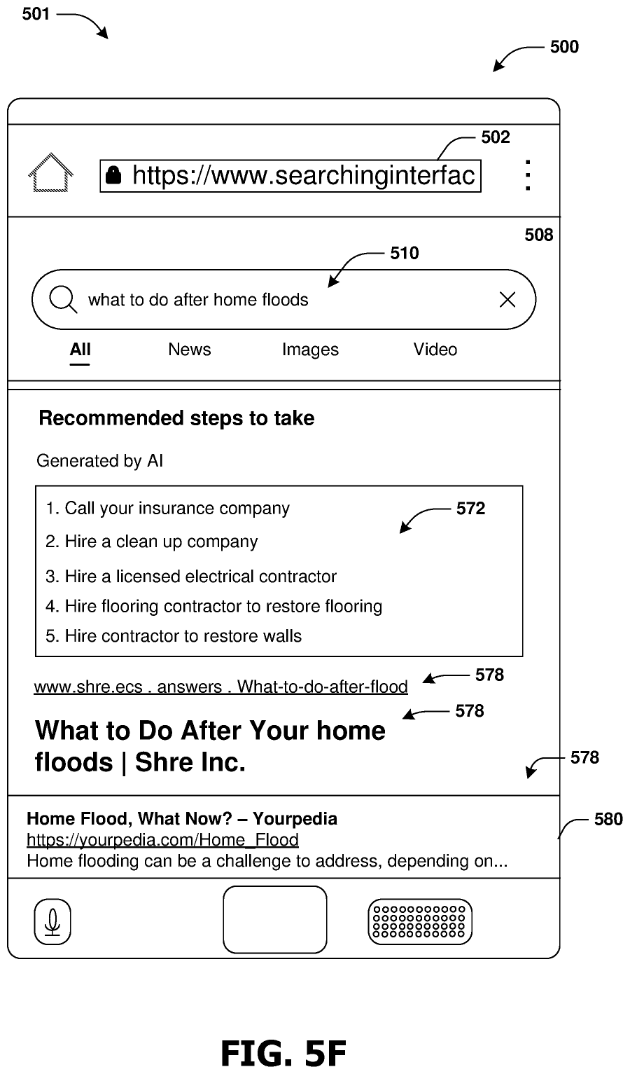

An embodiment of providing summaries in response to queries is illustrated by an example method 400 of FIG. 4, and is further described in conjunction with a system 501 of FIGS. 5A-5F. In some examples, a content system is provided. A first user, such as user Jill, (and/or a first client device associated with the first user) may access and/or interact with a service, such as a browser, software, a website, an application, an operating system, an email interface, a messaging interface, a music-streaming application, a video application, a news application, etc. that provides a platform for viewing and/or downloading content items (e.g., sets of text, images, audio, videos, etc.) from a server associated with the content system. In some examples, the content system may use user information, such as a first user profile comprising activity information (e.g., search history information, website browsing history, email information, selected content items, etc.), demographic information associated with the first user, health information associated with the user, location information, etc. to determine interests of the first user and/or select content for presentation to the first user based upon the interests of the first user.

At 402, the content system may receive, from the first client device, a first query (e.g., a search query). In some examples, the content system may receive the first query via a search interface displayed on the first client device. In some examples, the content system may provide a search engine used to provide search results in response to queries received via the search interface. FIG. 5A illustrates the first client device (shown with reference number 500) presenting and/or accessing the search interface (shown with reference number 508). The first client device 500 may comprise at least one of a phone, a laptop, a computer, a wearable device, a smart device, a television, any other type of computing device, hardware, etc. The search interface 508 may be displayed via a web page using a browser of the first client device 500. The browser may comprise an address bar 502 comprising a web address (e.g., a URL) of the web page. The search interface 508 may be associated with the search engine (e.g., a web search engine designed to search for information throughout the Internet). In some examples, the search interface 508 may comprise a search field 506. For example, the first query (shown with reference number 510) may be entered into the search field 506. In an example, the first query 510 may comprise text (e.g., “what to do after car accident”). In some examples, the search interface 508 may comprise a search selectable input 504 corresponding to performing a search based upon the query. The content system may receive the first query 510 in response to a selection of the search selectable input 604.

At 404, in response to the first query 510, the content system (e.g., the search engine of the content system) may generate a plurality of search results corresponding to a plurality of internet resources associated with the first query 510. An internet resource of the plurality of internet resources may correspond to a web page and/or at least a portion of an application (e.g., a web application, a mobile application, etc.). In some examples, the plurality of search results may be generated based upon a determination that one or more parts of the first query 510 matches one or more parts of each internet resource of the plurality of internet resources. In some examples, the plurality of search results may be ranked based upon levels of relevance to the first query 510. In some examples, the plurality of search results may comprise a subset of a second plurality of search results determined for the first query 510. For example, the plurality of search results may comprise a set of top N ranked search results among the second plurality of search results. In some examples, N may be between at least 5 (e.g., top 5 ranked search results) and at most 15 (e.g., top 15 ranked search results). Other values of N are within the scope of the disclosure.

In an example, a first search result of the plurality of search results may be associated with a first internet resource (e.g., a first web page), a second search result of the plurality of search results may be associated with a second internet resource (e.g., a second web page), etc. The first search result may have a first search result ranking and/or the second search result may have a second search result ranking. The first search result ranking may be higher than the second search result ranking based upon a first level of relevance of the first search result (e.g., a level of relevance of the first internet resource to the first query 510) being higher than a second level of relevance of the second search result (e.g., a level of relevance of the second internet resource to the first query 510).

At 406, the content system may generate a plurality of content items based upon the plurality of search results. In some examples, for each search result of the plurality of search results, the plurality of content items may comprise a set of content items (e.g., a set of one or more content items) generated based upon the search result. For example, the content system may (i) generate a first set of content items (e.g., a first set of one or more content items) based upon the first search result, (ii) generate a second set of content items (e.g., a second set of one or more content items) based upon the second search result, and/or (iii) generate other sets of content items based upon other search results of the plurality of search results. In some examples, a content item of the plurality of content items (and/or each content item of the plurality of content items) is generated to include readable content (e.g., human readable content).

The content system may generate the first set of content items using a plurality of content extraction models. In some examples, the plurality of content extraction models may be associated with (i) different content extraction parameters (e.g., one content extraction model may have one or more different content extraction parameters than another content extraction model), (ii) different content extraction recall rates (e.g., one content extraction model may have a higher recall than another content extraction model), (iii) different content extraction precision levels (e.g., one content extraction model may have a higher precision than another content extraction model), and/or (iv) different content extraction mechanisms (e.g., one content extraction model may use a first content extraction mechanism to generate a content item from a search result and another content extraction model may use a second content extraction mechanism to generate a content item from the search result). For example, the content system may (i) generate a first content item of the first set of content items based upon the first search result using a first content extraction model of the plurality of content extraction models, (ii) generate a second content item of the first set of content items based upon the first search result using a second content extraction model of the plurality of content extraction models, (iii) generate a third content item of the first set of content items based upon the first search result using a third content extraction model of the plurality of content extraction models, and/or (iv) generate one or more other content items of the first set of content items based upon the first search result using one or more other content extraction models of the plurality of content extraction models. Examples of one or more content extraction models used to generate one or more of the first set of content items include at least one of jusText, Newspaper3K, and/or other content extraction tools.

In some examples, the first content item of the first set of content items is generated by (i) accessing internet resource data of the first internet resource (e.g., the internet resource data may comprise raw webpage data, such as raw HyperText Markup Language (HTML) data) and/or (ii) extracting content (e.g., readable content, such as human readable content), from the raw webpage data, for inclusion in the content item using the first content extraction model. In some examples, the content system may identify (using the first content extraction model, for example) undesired data in the internet resource data and/or may not include the undesired data in the first content item. The undesired data may include at least one of structural elements (e.g., <head>, <body>, <nav>, <section>, etc.), text content (e.g., <p>, <h1>, <h2>, <div>, etc.), links (e.g., navigation links), headers, uniform resource locators (URLs), images, videos, media, metadata, headers, and/or other data. In some examples, excluding the undesired data from the first content item may provide for reduced noise of the first content item and/or reduced irrelevant information for summary generation.

Other sets of content items associated with other search results of the plurality of search results may be determined using one or more of the techniques provided herein with respect to determining the first set of content items.

FIG. 5B illustrates generation of the plurality of content items (shown with reference number 552) based upon the plurality of search results (shown with reference number 550). In some examples, the plurality of search results 550 may comprise N search results associated with N internet resources (e.g., Webpage 1, Webpage 2, . . . , Webpage N). In some examples, the plurality of content items 552 may comprise M×N content items, wherein M denotes a quantity of content extraction models of the plurality of content extraction models. In the example shown in FIG. 5B, the quantity of content extraction models, M, may be equal to 3, and thus, the plurality of content items 552 may comprise 3×N content items (e.g., when N=10, the plurality of content items 552 may comprise 30 content items which may include a set of three content items generated using three content extraction models for each search result of the 10 search results). Content items generated using the first content extraction model may be labeled with “Tool-1”. Content items generated using the second content extraction model may be labeled with “Tool-2”. Content items generated using the third content extraction model may be labeled with “Tool-3”. The first set of content items may comprise the first content item labeled “Webpage 1-Tool-1”, the second content item labeled “Webpage 1-Tool-2” and/or the third content item labeled “Webpage 1-Tool-3”. The second set of content items may comprise a fourth content item labeled “Webpage 2-Tool-1” (generated based upon the second search result using the first content extraction model), a fifth content item labeled “Webpage 2-Tool-2” (generated based upon the second search result using the second content extraction model) and/or a sixth content item labeled “Webpage 2-Tool-3” (generated based upon the second search result using the third content extraction model).

FIG. 5C illustrates the first content extraction model (shown with reference number 543) being used to generate the first content item (shown with reference number 544) based upon the internet resource data (shown with reference number 542) of the first internet resource (e.g., raw webpage data, such as raw HTML data). Embodiments are contemplated in which the first set of content items is generated using merely a single content extraction model (and/or the first set of content items comprises merely a single content item generated using the single content extraction model based upon the first search result).

At 408, the content system may use a language model to generate a plurality of summaries based upon the plurality of content items 552. In some examples, for each content item of the plurality of content items 552, the content system may generate a summary of the content item. For example, the content system may (i) generate a first set of summaries (e.g., a first set of one or more summaries) based upon the first set of content items, (ii) generate a second set of summaries (e.g., a first second of one or more summaries) based upon the second set of content items, and/or (iii) generate other summaries based upon other content items of the plurality of content items 552.

FIG. 5D illustrates generation of the plurality of summaries (shown with reference number 554) based upon the plurality of content items 552. In some examples, a quantity of summaries of the plurality of summaries 554 may be equal to a quantity of content items of the plurality of content items 552. Summaries generated from content items generated using the first content extraction model 543 may be labeled with “Tool-1”. Content items generated from content items generated using the second content extraction model may be labeled with “Tool-2”. Content items generated from content items generated using the third content extraction model may be labeled with “Tool-3”. The first set of summaries may comprise a first summary (labeled “Webpage 1-Tool-1 Summary”) generated based upon the first content item, a second summary (labeled “Webpage 1-Tool-2 Summary”) generated based upon the second content item and/or a third summary (labeled “Webpage 1-Tool-3 Summary”) generated based upon labeled “Webpage 1-Tool-3”. The second set of summaries may comprise a fourth summary (labeled “Webpage 2-Tool-1 Summary”) generated based upon the fourth content item, a fifth summary (labeled “Webpage 2-Tool-2 Summary”) generated based upon the fifth content item and/or a sixth summary (labeled “Webpage 2-Tool-3 Summary”) generated based upon the sixth content item.

FIG. 5E illustrates the language model (shown with reference number 570) being used to generate the first summary (shown with reference number 572) based upon the first content item 544 associated with the first internet resource. In some examples, the language model 570 may comprise a generative artificial intelligence (AI) model, such as large language model (LLM). In some examples, the language model 570 is configured to generate a summary (comprising text and/or at least one of images, audio, video, etc., for example) based upon an input.

In some examples, the language model 570 comprises one or more machine learning models (e.g., generative machine learning models). In some examples, the one or more machine learning models may comprise one or more generative pre-trained transformer models. In some examples, the one or more machine learning models may comprise one or more text generation models (to generate text of the first summary 572, for example).

In some examples, the language model 570 may be trained (e.g., pre-trained) and/or fine-tuned using one or more datasets (e.g., a knowledge base for generating text) to enable the language model 570 to understand language context and/or generate text. the one or more datasets may comprise at least one of a corpus, such as a text corpus, one or more dictionaries, one or more lists of terms, one or more encyclopedias, one or more online encyclopedias, one or more news channel resources, one or more news websites, one or more websites, one or more books, one or more research articles, one or more research article databases, one or more informational databases, etc.) and/or other resources, which may enable the language model 570 to develop a deep understanding of language context, thereby enabling the content system to comprehend users' queries (e.g., search queries with questions and/or requests) more accurately and/or leading to better summarization results.

One, some and/or all machine learning models of the language model 570 may, for example, comprise at least one of a neural network, a tree-based model, a machine learning model used to perform linear regression, a machine learning model used to perform logistic regression, a decision tree model, a support vector machine (SVM), a Bayesian network model, a k-Nearest Neighbors (k-NN) model, a K-Means model, a random forest model, a machine learning model used to perform dimensional reduction, a machine learning model used to perform gradient boosting, etc.

In an example, the language model 570 may be based upon a base model (e.g., an open source model and/or other type of model), such as Google® Flan-T5-XL model and/or other model. In some examples, the base model may be fine-tuned using a dataset of instruction-following records (e.g., an open-source dataset and/or other type of dataset), such as Databricks @Dolly-15k and/or other dataset of instruction-following records. In some examples, the base model comprises and/or is based upon an open source model and/or may be free for commercial use. In some examples, the base model is fine-tuned using non-proprietary data.

In some examples, the language model 570 generates the first summary 572 based upon a first set of guidance information input to the language model 570. The first set of guidance information may comprise instructions (e.g., chain-of-thought (COT) instruction) based upon which the language model 570 may generate the first summary 572 based upon the first content item 544. In an example, the first set of guidance information may comprise (i) an instruction to identify and/or extract portions of the first content item 544 (e.g., sentences and/or phrases of the first content item 544) that are relevant to the first query 510 (e.g., portions of the first content item 544 that are proper suggestions for a question and/or request indicated by the first query 510) and/or (ii) an instruction to format the portions (e.g., summary items) to a numbered list to generate the first summary 572. In an example, the first set of guidance information may comprise <From the INPUT passage provided below: First, find and extract sentences that are proper suggestions for answering the question ‘{query}’; Second, format the answers to a numbered list .\nINPUT:\n\″\″\″\n{content}\n\″\″\″>, where “INPUT passage” may correspond to the first content item 544 and/or ‘{query}’ may correspond to the first query 510.

In some examples, the first summary 572 may comprise a plurality of summary items. A summary item of the plurality of summary items may comprise a portion of the first content item 544 (e.g., at least a portion of a sentence of the first content item 544). In some examples, a summary item of the plurality of summary items may comprise an unedited and/or unchanged version of a portion of the first content item 544 (e.g., an unedited and/or unchanged version of at least a portion of a sentence of the first content item 544). In some examples, a summary item of the plurality of summary items may comprise an edited and/or changed version of a portion of the first content item 544. For example, the language model 570 may modify a portion of the first content item 544 (e.g., at least a portion of a sentence of the first content item 544) to generate a summary item comprising an edited and/or changed version of the portion of the first content item 544. In some examples, the plurality of summary items may be numbered. In some examples, the plurality of summary items may be arranged (e.g., spatially arranged) and/or numbered based upon an order of instructions and/or tasks associated with the first query 510. In the example shown in FIG. 5E, the plurality of summary items may comprise (i) a first summary item “1. Call your insurance company”, (ii) a second summary item “2. Hire a clean up company”, (iii) a third summary item “3. Find a contractor”, etc.

In some examples, the content system may perform a relevance check (e.g., question answer check) to identify summary items that are determined not to be relevant to the first query 510 and/or filter the identified summary items (e.g., irrelevant summary items) from the first summary 572. In some examples, the content system may use the language model 570 to perform the relevance check. The content system may perform the relevance check to determine relevance statuses of summary items of an initial summary generated using the language model 570 based upon the first content item 544 and/or the guidance information. In some examples, a relevance status of a summary item of the initial summary may indicate whether the summary item is relevant to the first query 510 (e.g., whether the summary item is a relevant answer to a question and/or request indicated by the first query 510). In an example in which the initial summary comprises eight summary items, the relevance check may produce an 8-dimension vector with binary values indicative of eight relevance statuses (e.g., a binary value may be YES or NO, wherein YES may indicate a corresponding summary item is relevant to the first query 510 and/or NO may indicate the corresponding summary item is not relevant to the first query 510). The content system may generate the first summary 572 based upon the initial summary and the relevance statuses.

In some examples, the language model 570 performs the relevance check based upon a second set of guidance information input to the language model 570. The second set of guidance information may comprise instructions based upon which the language model 570 may perform the relevance check on the initial summary to determine the relevance statuses. In an example, the second set of guidance information may comprise an instruction to determine a relevance status for a summary item of the initial summary (e.g., an instruction to determine whether a summary item is a relevant answer to a question and/or request indicated by the first query 510). In an example, the second set of guidance information may comprise <Given the question “{query}”, is the statement “{item}” a relevant answer? YES or NO.>, where “{query}” may correspond to the first query 510 and/or “{item}” may correspond to a summary item.

In some examples, the relevance check may produce results indicating that (i) one or more first summary items of the initial summary are relevant to the first query 510 (e.g., the one or more first summary items are determined to be relevant answers to a question and/or request indicated by the first query 510), and/or (ii) one or more second summary items of the initial summary are not relevant to the first query 510 (e.g., the one or more second summary items are determined not to be relevant answers to a question and/or request indicated by the first query 510). Based upon the relevance check, the content system may remove the one or more second summary items of the initial summary to generate the first summary 572. For example, the content system may generate the first summary 572 to (i) include summary items (e.g., the one or more first summary items) that are determined to be relevant to the first query 510 and/or (ii) exclude summary items (e.g., the one or more second summary items) that are determined not to be relevant to the first query 510. In some examples, if all of the relevance statuses produced by the relevance check indicate that corresponding summary items of the initial summary are relevant to the first query 510 (e.g., all of the relevance statuses indicate YES), the first summary 572 may be the same as the initial summary.

Embodiments are contemplated in which a second language model different than the language model 570 is used to perform the relevance check.

Other summaries of the plurality of summaries 554 may be generated using one or more of the techniques provided herein with respect to generating the first summary 572.

At 410, the content system may determine summary scores (e.g., aggregated ranking scores) of the plurality of summaries 554. For example, the summary scores may comprise a first summary score of the first summary 572, a second summary score of the second summary, a third summary score of the third summary, a fourth summary score of the fourth summary, a fifth summary score of the fifth summary, a sixth summary score of the sixth summary and/or other summary scores of other summaries of the plurality of summaries 554.

In some examples, the first summary score of the first summary 572 may be determined based upon the relevance statuses associated with the first summary 572 and/or the initial summary. For example, a relevance status score may be determined based upon the relevance statuses. In some examples, the relevance status score may be a function of an amount of YES relevance statuses and/or an amount of NO relevance statuses. In some examples, the relevance status score corresponds to a ratio of YES relevance statuses to total relevance statuses of the initial summary. In an example in which the initial summary comprises ten summary items and the relevance statuses produced by the relevance check indicate that eight of the ten summary items are relevant to the first query 510, the relevance status score (e.g., the ratio) may be determined to be 0.8 (e.g., 8/10). In some examples, the relevance status score is used to determine the first summary score.

In some examples, the first summary score of the first summary 572 may be determined based upon a quantity of summary items of the first summary 572. For example, a summary size score may be determined based upon the quantity of summary items. In some examples, the summary size score may be determined based upon a comparison of the quantity of summary items with a predefined range of summary item quantities. The predefined range of summary item quantities may correspond to a range from three summary items to ten summary items (and/or other range). In some examples, in comparison with a scenario in which the quantity of summary items is outside the predefined range of summary item quantities, the summary size score may be higher when the quantity of summary items is within the predefined range of summary item quantities. In some examples, when the quantity of summary items is higher than the predefined range of summary item quantities, the summary size score may be based upon a difference between the quantity of summary items and a maximum value (e.g., ten) of the predefined range of summary item quantities (e.g., the summary size score may be a function of the difference, where an increase of the difference may correspond to a decrease of the summary size score). In some examples, when the quantity of summary items is lower than the predefined range of summary item quantities, the summary size score may be based upon a difference between the quantity of summary items and a minimum value (e.g., three) of the predefined range of summary item quantities (e.g., the summary size score may be a function of the difference, where an increase of the difference may correspond to a decrease of the summary size score). In some examples, the summary size score is used to determine the first summary score.

In some examples, the first summary score of the first summary 572 may be determined based upon item sizes of summary items of the first summary 572. For example, an item size of a summary item may correspond to at least one of a quantity of words, a quantity of characters, etc. of the summary item. In some examples, the content system may determine an average item size based upon the item sizes of the summary items of the first summary 572 (e.g., at least one of a mean, a median, etc. of the item sizes). In some examples, an item size score may be determined based upon the average item size (and/or the item sizes of the summary items of the first summary 572). In some examples, the item size score may be determined based upon a comparison of the average item size with a predefined range of item sizes. The predefined range of item sizes may correspond to a range from five words to 35 words (and/or other range). In some examples, in comparison with a scenario in which the average item size is outside the predefined range of item sizes, the item size score may be higher when the average item size is within the predefined range of item sizes. In some examples, when the average item size is higher than the predefined range of item sizes, the item size score may be based upon a difference between the average item size and a maximum value (e.g., 35) of the predefined range of item sizes (e.g., the item size score may be a function of the difference, where an increase of the difference may correspond to a decrease of the item size score). In some examples, when the average item size is lower than the predefined range of item sizes, the item size score may be based upon a difference between the average item size and a minimum value (e.g., five) of the predefined range of item sizes (e.g., the item size score may be a function of the difference, where an increase of the difference may correspond to a decrease of the item size score). In some examples, the item size score is used to determine the first summary score.

In some examples, the first summary score of the first summary 572 may be determined based upon the first search result ranking of the first search result (based upon which the first summary 572 is generated, for example). In some examples, a search result ranking score of the first summary 572 may be a function of the first search result ranking, where a higher ranking may correspond to an increase of the search result ranking score (e.g., the search result ranking score may be higher if the first search result is the top-ranked search result of the plurality of search results 550 than if the first search result is ranked lower than the top-ranked search result of the plurality of search results 550). In some examples, the search result ranking score may be determined based upon a determination of whether the first search result is among the top p search results of the plurality of search results 550, where p may correspond to 3 or other value. In some examples, in comparison with a scenario in which the first search result is not among the top p search results of the plurality of search results 550, the search result ranking score may be higher when the first search result is among the top p search results of the plurality of search results 550. In some examples, the search result ranking score is used to determine the first summary score.

In some examples, the first summary score of the first summary 572 may be determined based upon a coverage score of the first summary 572. The coverage score may be indicative of how well the first summary 572 covers information (related to the first query 510, for example) from other sources other than the first search result. The coverage score may be determined based upon a first similarity score associated with a similarity between at least a portion of the first summary 572 and first content associated with one or more search results (of the plurality of search results 550) different than the first search result. The first content may be associated with (e.g., may be extracted from) one or more internet resources (e.g., at least one of the second internet resource and/or one or more other internet resources) corresponding to one or more search results different than the first search result. For example, the first content may comprise at least a portion of the fourth content item, at least a portion of the fifth content item, at least a portion of the sixth content item, etc. In an example, the first similarity score may be determined based upon at least one of a measure (e.g., quantity) of words that are common to a summary item of the first summary 572 and the first content, a measure (e.g., quantity) of phrases that are common to a summary item of the first summary 572 and the first content, etc. Alternatively and/or additionally, the first similarity score may correspond to an embedding similarity (e.g., cross-document similarity). The first similarity score may be determined based upon a first representation associated with the first summary 572 and a second representation associated with the first content. In an example, the first representation may comprise an embedding based representation (e.g., an embedding) of at least a portion of the first summary 572 and/or a vector representation of at least a portion of the first summary 572. Alternatively and/or additionally, the second representation may comprise an embedding based representation (e.g., an embedding) of at least a portion of the first content and/or a vector representation of at least a portion of the first content. In some examples, the first representation and/or the second representation may be generated using a natural language processing (NLP) model. In some examples, the NLP model comprises a language representation model, such as a Bidirectional Encoder Representations from Transformers (BERT) model. In an example, one or more operations (e.g., mathematical operations) may be performed using the first representation and the second representation to determine the first similarity score (e.g., the first similarity score may be based upon (and/or may be equal to) a measure of similarity between the first representation and the second representation, such as a cosine similarity between the first representation and the second representation). In some examples, the first similarity score is generated using the NLP model. In some examples, the coverage score of the first summary 572 may be a function of the first similarity score, where a higher value of the first similarity score may correspond to an increase of the coverage score. In some examples, the coverage score is used to determine the first summary score.

In some examples, the first summary score of the first summary 572 may be determined based upon a fact score of the first summary 572. The fact score may be indicative of how well the first summary 572 covers information (related to the first query 510, for example) of the first internet resource associated with the first search result. The fact score may be determined based upon a second similarity score associated with a similarity between at least a portion of the first summary 572 and second content associated with the first search result. The second content may be associated with (e.g., may be extracted from) the first internet resource corresponding to the first search result. For example, the second content may comprise at least a portion of the first content item 544, at least a portion of the second content item, at least a portion of the third content item, etc. In an example, the second similarity score may be determined based upon at least one of a measure (e.g., quantity) of words that are common to a summary item of the first summary 572 and the second content, a measure (e.g., quantity) of phrases that are common to a summary item of the first summary 572 and the second content, whether a summary item of the first summary 572 matches (e.g., is an exact or non-exact match with) a portion of the second content, etc. Alternatively and/or additionally, the second similarity score may be based upon an embedding similarity. The second similarity score may be determined based upon a third representation associated with the first summary 572 and a fourth representation associated with the second content. In an example, the third representation may comprise an embedding based representation (e.g., an embedding) of at least a portion of the first summary 572 and/or a vector representation of at least a portion of the first summary 572. Alternatively and/or additionally, the fourth representation may comprise an embedding based representation (e.g., an embedding) of at least a portion of the second content and/or a vector representation of at least a portion of the second content. In some examples, the third representation and/or the fourth representation may be generated using the NLP model. In an example, one or more operations (e.g., mathematical operations) may be performed using the third representation and the fourth representation to determine the second similarity score (e.g., the second similarity score may be based upon (and/or may be equal to) a measure of similarity between the third representation and the fourth representation, such as a cosine similarity between the third representation and the fourth representation). In some examples, the second similarity score is generated using the NLP model. In some examples, the fact score of the first summary 572 may be a function of the second similarity score, where a higher value of the second similarity score may correspond to an increase of the fact score. In some examples, the fact score may be determined using the language model 570 (by using the language model 570 to perform a fact check, for example). Embodiments are contemplated in which a third language model different than the language model 570 is used to perform the fact check to determine the fact score. In some examples, the fact score is used to determine the first summary score.

In some examples, the first summary score of the first summary 572 may be determined based upon a diversity score of the first summary 572. The diversity score may be indicative of a level of diversity of summary items of the first summary 572. In some examples, the diversity score may be determined based upon one or more redundancy scores associated with one or more pairs of summary items of the first summary 572. For example, a first redundancy score of the one or more redundancy scores may be associated with a first pair of summary items of the first summary 572. In some examples, the first redundancy score may be determined based upon a third similarity score associated with a similarity between the first pair of summary items. In some examples, the third similarity score may be based upon a lexical similarity between the first pair of summary items (e.g., the lexical similarity may be associated with shared prefixes between the first pair of summary items) and/or a semantic similarity between the first pair of summary items (e.g., the semantic similarity may be associated with pairwise similarity between the first pair of summary items). In a first scenario in which the first pair of summary items comprise summary item “call an emergency line” and summary item “call 911”, the third similarity score and/or the first redundancy score may be determined to be higher than in a second scenario in which the first pair of summary items comprise summary item “call an emergency line” and summary item “call your insurance provider” (such as due, at least in part, to the first scenario being redundant and/or the second scenario not being redundant). In some examples, the diversity score may be a function of the third similarity score and/or the first redundancy score (and/or other similarity scores and/or redundancy scores associated with other pairs of summary items of the first summary 572, for example), wherein a lower value of the third similarity score and/or the first redundancy score may correspond to an increase of the diversity score. In some examples, the diversity score is used to determine the first summary score.

In some examples, the first summary score of the first summary 572 may be determined based upon the relevance status score, the summary size score, the item size score, the search result ranking score, the coverage score, the fact score and/or the diversity score. For example, the content system may perform one or more operations (e.g., mathematical operations) using the relevance status score, the summary size score, the item size score, the search result ranking score, the coverage score, the fact score and/or the diversity score to determine the first summary score. In an example, the first summary score may correspond to the relevance status score multiplied by a weighted sum of the summary size score, the item size score, the search result ranking score, the coverage score, the fact score and/or the diversity score, such as in the following equation:

$${score}_{a g g} = ( {w}_{1} f e a {t}_{fact} + {w}_{2} f e a {t}_{c o v} + {w}_{3} f e a {t}_{div} + {w}_{4} f e a {t}_{s u m m a r {y}_{s i z e}} + {w}_{5} f e a {t}_{{item}_{s i z e}} + {w}_{6} f e a {t}_{r a n k} ) \times rel\_status \_score ,$$

where feat_{fact} corresponds to the fact score, feat_{cov} corresponds to the coverage score, feat_{div} corresponds to the diversity score, feat_{summary}_{_{size}} corresponds to the summary size score, featᵢₜₑₘ_{_{size}} corresponds to the item size score, featᵣₐₙₖ corresponds to the search result ranking score, rel_check_score corresponds to the relevance status score, and/or w₁, w₂, w₃, w₄, w₅ and/or w₆ correspond to weights.

Other summary scores of other summaries of the plurality of summaries 554 may be determined using one or more of the techniques provided herein with respect to determining the first summary score of the first summary 572.

At 412, the content system may select the first summary 572 from the plurality of summaries 554 based upon the summary scores (e.g., aggregated ranking scores) of the plurality of summaries 554. For example, the content system may select the first summary 572 based upon a determination that the first summary score is a highest summary score of the summary scores of the plurality of summaries 554.

At 414, in response to selecting the first summary 572, the content system may provide the first summary 572 for display on the first client device 500. For example, the first summary 572 may be displayed via the search interface 508. In some examples, one or more search results of the plurality of search results 550 may be displayed via the search interface 508. For example, the first summary 572 may be displayed concurrently on the search interface 508 with one or more search results of the plurality of search results 550. In some examples, the one or more search results may be arranged according to search result rankings of the search results (e.g., a search result ranked higher than the second search result may be displayed at least one of above, before, etc. the second search result).

FIG. 5F illustrates the search interface 508 displaying the first summary 572 and/or a list of search results 578 associated with the first query 510. For example, the search interface 508 may display the summary 576 above the list of search results 578. The list of search results 578 may be arranged based upon search result rankings and/or may comprise a representation 580 of a search result of the plurality of search results 550 and/or other search results of the plurality of search results 550. The representation 580 of the search result may be usable to access an internet resource associated with the search result. In some examples, the search interface 508 may display a link 578 to the first internet resource 578 and/or an indication 578 of the first internet resource 578 (e.g., a title 578 of an article of the first internet resource 578). The link 578 may be usable to access the first internet resource associated with the first summary 572. In some examples, the first summary 572 may comprise a summary list comprising list items representative of a set of instructions and/or tasks (e.g., series of instructions and/or tasks) for a reader to consider for addressing an issue (e.g., home flooding) indicated by the first query 510.

Using the techniques provided herein may provide for benefits including (i) improved accuracy of the first summary 572 and/or the summary items of the first summary 572 (e.g., list items of the summary list) (ii) a more accurate representation of the set (e.g., series) of instructions and/or tasks associated with the issue and/or (iii) reduced redundancy between summary items of the first summary 572. The benefits may be due, at least in part, to (i) more stable performance of the language model 570 and/or (ii) using a single search result and/or a single content item to generate a summary (e.g., the first summary 572 may be generated using the first search result and/or the first internet resource, the second summary may be generated using the second search result and/or the second internet resource, etc.), which may reduce a likelihood that the summary includes redundant items (as compared with generating a summary using multiple web pages of multiple search results, for example, which may increase a likelihood that redundant items from the multiple web pages are included in the summary).

Alternatively and/or additionally, it may be appreciated that using the techniques provided herein may provide for enhanced diversity (e.g., variation in quality, content, etc.) of the plurality of summaries 554 (e.g., candidate summaries from which to select a summary to present to the first user), such as due, at least in part, to generating the plurality of content items 552 using multiple content extraction models. The enhanced diversity of the plurality of summaries 554 may provide for improved quality of a resulting summary (e.g., the first summary 572) selected from the plurality of content items 552, such as due, at least in part, to there being a higher likelihood of the plurality of summaries 554 including a higher quality summary (as compared to a system that generates merely one or more summaries with low diversity, for example, which may have a lower likelihood of including a higher quality summary).

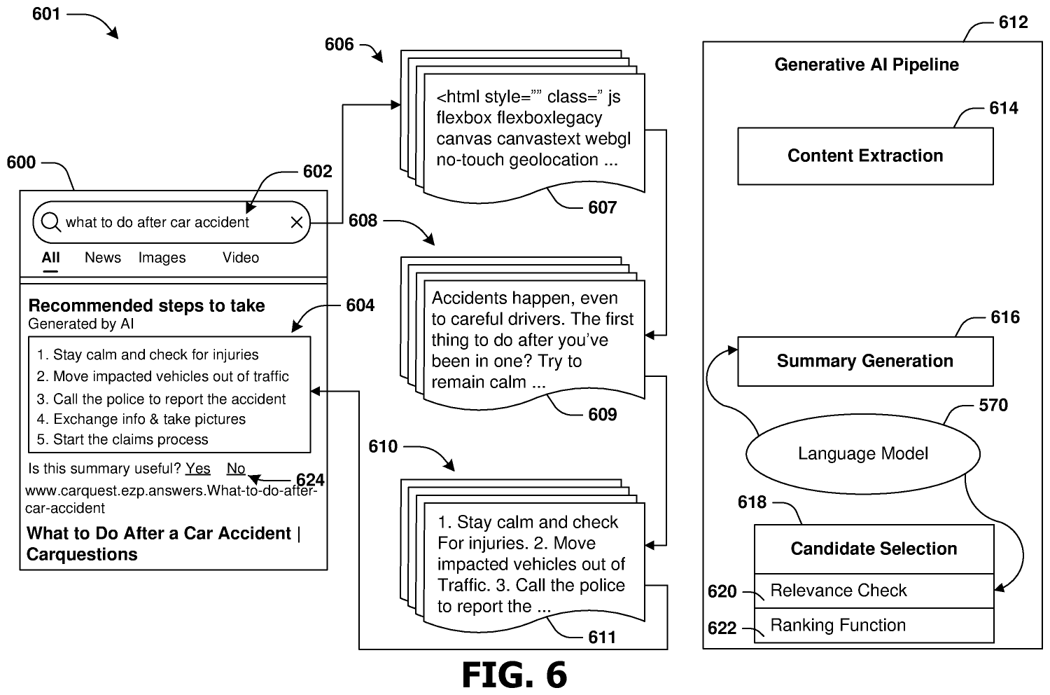

FIG. 6 illustrates a system 601 for automatically providing summaries in response to search queries. The system 601 may comprise a generative AI pipeline 612, which may be used by the content system to generate a summary 604 in response to a query 602 from a client device 600 (e.g., at least one of a phone, a laptop, a computer, a wearable device, a smart device, a television, any other type of computing device, hardware, etc.). The content system may derive a plurality of sets of internet resource data 606 (e.g., raw webpage data, such as raw HTML data) from top N ranked search results (e.g., top 5 ranked search results, top 10 ranked search results, etc.) of a plurality of search results determined by the content system based upon the query 602.

The generative AI pipeline 612 may comprise a content extraction module 614 comprising one or more content extraction models (e.g., the first content extraction model 543 and/or one or more other content extraction models) to generate a plurality of content items 608 (e.g., readable content items, such as human-readable content items) based upon the plurality of sets of internet resource data 606. For example, the plurality of content items 608 may comprise a first content item 609 generated based upon (e.g., extracted from) a first set of internet resource data 607 of the plurality of sets of internet resource data 606.

The generative AI pipeline 612 may comprise a summary generation module 616 that uses the language model 570 to generate a plurality of candidate summaries 610 based upon the plurality of content items 608. For example, the plurality of candidate summaries 610 may comprise a first candidate summary 611 generated based upon the first content item 609.

The generative AI pipeline 612 may comprise a candidate selection module 618 comprising a relevance check function 620 (e.g., question answer check) and/or a ranking function 622. The relevance check function 620 may use the language model 570 to perform a relevance check to (ii) determine relevance statuses of summary items of the plurality of candidate summaries 610, (ii) remove summary items that are determined to be irrelevant (and/or not sufficiently relevant) to the query 602, and/or (iii) determine relevance status scores of the plurality of candidate summaries 610. The ranking function 622 of the candidate selection module 618 may select the summary 604 (e.g., the first candidate summary 611) from among the plurality of candidate summaries 610 by (i) determining summary scores of the plurality of candidate summaries 610 (using the relevance status scores and/or other information), (ii) ranking the plurality of candidate summaries 610 according to the summary scores, and/or (iii) selecting the top-ranked candidate summary (e.g., the first candidate summary 611) from among the plurality of candidate summaries 610. The summary 604 (e.g., the first candidate summary 611) may be provided for display on the client device 600 in response to the selection.

In some examples, summary items of the summary 604 may be arranged (e.g., spatially arranged) and/or numbered based upon an order of instructions and/or tasks associated with the query 602. For example, the summary 604 may include a first summary item (e.g., “1. Stay calm and check for injuries”) above and/or before a second summary item (e.g., “2. Move impacted vehicles out of traffic”) based upon a determination that a first task associated with the first summary item (e.g., checking for injuries) should be performed and/or considered before a second task associated with the second summary item (e.g., moving vehicles out of traffic).

In some examples, user response information associated with a user response to the summary 604 may be recorded by the content system. The user response information may comprise (i) a view time of the summary 604 (e.g., how long the summary 604 is displayed on the client device 600 and/or viewed by the user of the client device 600), (ii) an indication of whether the user found the summary 604 useful (which may be determined based upon user feedback received via summary feedback interface 624 that may be displayed proximal the summary 604, for example), (iii) user activity information indicative of user activity of the user after being presented with the summary 604, and/or (iv) other information. The user activity information may comprise (i) an indication of whether the user navigated to an internet resource (of a search result, for example) to find information the user was looking for (which may indicate that the summary 604 did not provide sufficient information to satisfy the user's needs, for example), (ii) an indication of whether the user subsequently used the search engine provided by the content system (which may indicate that the user enjoyed the user experience provided by the search engine), and/or other user activity information. In some examples, the user response information and/or other user response information associated with the user and/or other users may be used as feedback to update one or more features of the generative AI pipeline 612, such as (i) update and/or train the language model 570 (e.g., one or more tunable parameters of a machine learning model of the language model 570 may be modified based upon the feedback to more accurately generate summaries that that users respond more positively to), (ii) update and/or train one or more content extraction models (e.g., the first content extraction model 543, the second content extraction model, etc.) of the content extraction module 614 and/or replace a content extraction model of the content extraction module 614 with a different content extraction model with improved performance to enhance performance of the generative AI pipeline 612, and/or (iii) update and/or train one or more parameters (e.g., weights w₁, w₂, w₃, w₄, w₅ and/or w₆ and/or other parameters) of the candidate selection module 618. It may be appreciated that updating and/or training the generative AI pipeline 612 based upon user responses from users may create a closed-loop process allowing results of events in which summaries are provided to users as feedback to tailor parameters of the generative AI pipeline 612. Closed-loop control may reduce errors and produce more efficient operation of a computer system which implements the generative AI pipeline 612. The reduction of errors and/or the efficient operation of the computer system may improve operational stability and/or predictability of operation. Accordingly, using processing circuitry to implement closed loop control described herein may improve operation of underlying hardware of the computer system.

Embodiments are contemplated in which the summary 604 comprises at least one of text, an image, a video, audio, and/or other type of content.

It may be appreciated that the disclosed subject matter may assist a user in understanding main points of information associated with a query submitted by the user (e.g., the information may comprise an answer to a question and/or request posed by the query) by automatically generating a summary based upon the query and/or presenting the summary to the user in response to the query. Alternatively and/or additionally, summary items of the summary being arranged as a list (e.g., being vertically arranged and/or comprising list symbols, such as numbering shown in FIG. 5F and FIG. 6, bullets, and/or other types of list symbols) may improve readability and/or assist the user in more quickly understanding answers to the question and/or request (as compared to other summary formats, such as summaries in paragraph format, that may be harder to read and/or follow).

Implementation of at least some of the disclosed subject matter may lead to benefits including a reduction in screen space and/or an improved usability of a display (e.g., of a client device) (e.g., as a result of providing the summary and/or displaying the summary such that summary items that may represent main points of requested information are automatically displayed via the client device, wherein the user may not be required to navigate through multiple web pages and/or open various tabs and/or windows to access the requested information, etc.). Alternatively and/or additionally, the disclosed subject matter may enable quicker access to relevant information, improve user interaction with the search engine of the content system, and/or streamline a user process for finding information about an issue. Alternatively and/or additionally, the disclosed subject matter may enhance depth and/or reliability in summaries delivered to users, and/or may increase user engagement and/or user retention.

Alternatively and/or additionally, implementation of at least some of the disclosed subject matter may lead to benefits including less manual effort (e.g., as a result of generating the summary automatically, wherein manual editing to produce the summary is not required).

In some examples, the client device 600 is configured to display a menu listing one or more features (e.g., selectable features) of the content system. The one or more features may comprise at least one of a search feature, a content feature, a messaging feature, a social media feed feature, etc. In an example, in response to a selection of the search feature, the search feature may provide one or more resources (e.g., the search interface 508, search functionality, etc.) for using the search engine of the content system to search for content. In an example, in response to a selection of the content feature, the content feature may provide one or more resources (e.g., data, an interface, etc.) for displaying and/or engaging with content items (e.g., videos, images, audio files, news articles, etc.). In response to a selection of the messaging feature, the messaging feature may provide one or more resources (e.g., data, an interface, etc.) for displaying and/or facilitating messaging conversations (e.g., private messaging conversations and/or public messaging conversations) between users of the content system (e.g., users of the content system may send messages to each other using the messaging feature of the content system). In response to a selection of the social media feed feature, the social media feed feature may provide one or more resources (e.g., data, an interface, etc.) for displaying social media posts and/or comments on a social media platform. In some examples, the client device is configured to display a content platform application summary that can be reached directly from the menu, wherein the content platform application summary displays a limited list of data offered within the one or more features. In some examples, each of the data in the limited list of data is selectable to launch the respective feature (of the one or more features) and enable the selected data to be seen within the respective feature. In some examples, the content platform application summary is displayed while the one or more features are in an un-launched and/or unopened state.

In some examples, at least some of the disclosed subject matter may be implemented on a client device, and in some examples, at least some of the disclosed subject matter may be implemented on a server (e.g., hosting a service accessible via a network, such as the Internet).

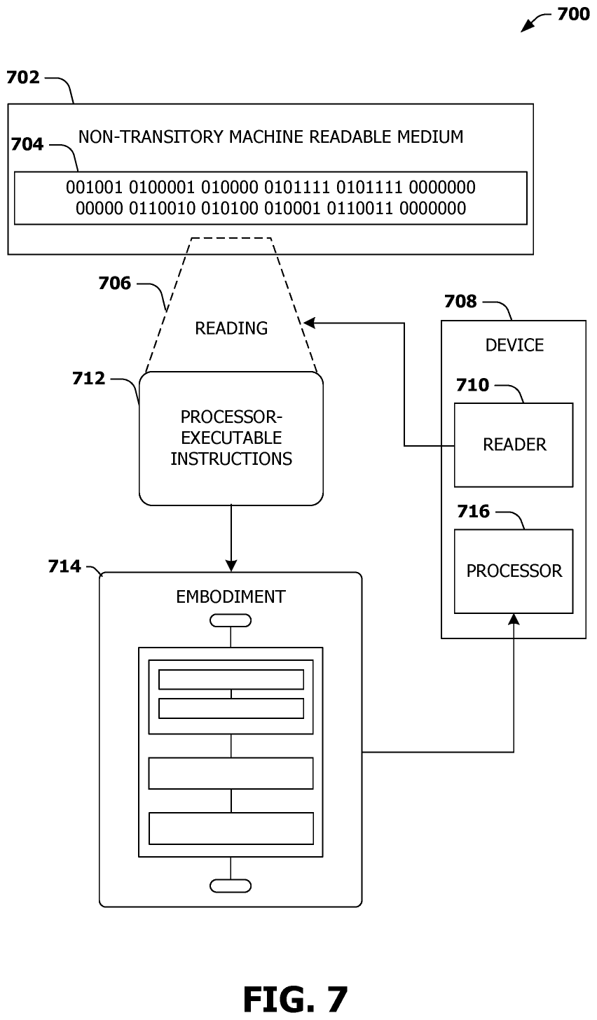

FIG. 7 is an illustration of a scenario 700 involving an example non-transitory machine readable medium 702. The non-transitory machine readable medium 702 may comprise processor-executable instructions 712 that when executed by a processor 716 cause performance (e.g., by the processor 716) of at least some of the provisions herein (e.g., embodiment 714). The non-transitory machine readable medium 702 may comprise a memory semiconductor (e.g., a semiconductor utilizing static random access memory (SRAM), dynamic random access memory (DRAM), and/or synchronous dynamic random access memory (SDRAM) technologies), a platter of a hard disk drive, a flash memory device, or a magnetic or optical disc (such as a compact disc (CD), digital versatile disc (DVD), or floppy disk). The example non-transitory machine readable medium 702 stores computer-readable data 704 that, when subjected to reading 706 by a reader 710 of a device 708 (e.g., a read head of a hard disk drive, or a read operation invoked on a solid-state storage device), express the processor-executable instructions 712. In some embodiments, the processor-executable instructions 712, when executed, cause performance of operations, such as at least some of the example method 400 of FIG. 4, for example. In some embodiments, the processor-executable instructions 712 are configured to cause implementation of a system, such as at least some of the example system 501 of FIGS. 5A-5F and/or at least some of the example system 601 of FIG. 6, for example.

### 3. Usage of Terms

As used in this application, “component,” “module,” “system”, “interface”, and/or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Unless specified otherwise, “first,” “second,” and/or the like are not intended to imply a temporal aspect, a spatial aspect, an ordering, etc. Rather, such terms are merely used as identifiers, names, etc. for features, elements, items, etc. For example, a first object and a second object generally correspond to object A and object B or two different or two identical objects or the same object.

Moreover, “example” is used herein to mean serving as an instance, illustration, etc., and not necessarily as advantageous. As used herein, “or” is intended to mean an inclusive “or” rather than an exclusive “or”. In addition, “a” and “an” as used in this application are generally be construed to mean “one or more” unless specified otherwise or clear from context to be directed to a singular form. Also, at least one of A and B and/or the like generally means A or B or both A and B. Furthermore, to the extent that “includes”, “having”, “has”, “with”, and/or variants thereof are used in either the detailed description or the claims, such terms are intended to be inclusive in a manner similar to the term “comprising”.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing at least some of the claims.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, many modifications may be made to this configuration without departing from the scope or spirit of the claimed subject matter.

Various operations of embodiments are provided herein. In an embodiment, one or more of the operations described may constitute computer readable instructions stored on one or more computer and/or machine readable media, which if executed will cause the operations to be performed. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein. Also, it will be understood that not all operations are necessary in some embodiments.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure. In addition, while a particular feature of the disclosure may have been disclosed with respect to only one of several implementations, such feature may be combined with one or more other features of the other implementations as may be desired and advantageous for any given or particular application.

What is claimed is:

1. A method, comprising:
receiving, from a client device, a query;
in response to the query, generating a plurality of search results corresponding to a plurality of internet resources associated with the query;
generating, using a first content extraction model, a first content item based upon a first search result of the plurality of search results;
generating, using a second content extraction model, a second content item based upon the first search result;
generating, using the first content extraction model, a third content item based upon a second search result of the plurality of search results;
generating, using the second content extraction model, a fourth content item based upon the second search result;
generating, using a language model, a plurality of summaries comprising:
a first summary of the first content item;
a second summary of the second content item;
a third summary of the third content item; and
a fourth summary of the fourth content item;
determining summary scores of the plurality of summaries;
selecting the first summary from the plurality of summaries based upon the summary scores; and
in response to selecting the first summary, providing the first summary for display on the client device.

2. The method of claim 1, comprising:
displaying a search interface on the client device, wherein the query is received via the search interface; and
in response to selecting the first summary, displaying the first summary via the search interface concurrently with displaying one or more representations of one or more search results of the plurality of search results via the search interface.

3. The method of claim 1, wherein generating the plurality of summaries comprises:
generating, using the language model, an initial summary comprising a plurality of summary items;
determining, based upon the plurality of summary items and the query, a plurality of relevance statuses comprising:
a first relevance status of a first summary item of the plurality of summary items, wherein the first relevance status indicates that the first summary item is relevant to the query; and
a second relevance status of a second summary item of the plurality of summary items, wherein the second relevance status indicates that the second summary item is not relevant to the query; and
generating the first summary based upon the initial summary and the plurality of relevance statuses.

4. The method of claim 3, wherein generating the first summary comprises:
including the first summary item in the first summary based upon the first relevance status indicating that the first summary item is relevant to the query; and
not including the second summary item in the first summary based upon the second relevance status indicating that the second summary item is not relevant to the query.

5. The method of claim 3, wherein determining the summary scores of the plurality of summaries comprises:
determining a first summary score of the first summary based upon the plurality of relevance statuses.

6. The method of claim 3, wherein determining the summary scores of the plurality of summaries comprises:
determining a first summary score of the first summary based upon a quantity of summary items of the plurality of summary items.

7. The method of claim 3, wherein determining the summary scores of the plurality of summaries comprises:
determining a first summary score of the first summary based upon item sizes of the plurality of summary items.

8. The method of claim 1, comprising:
determining rankings, of the plurality of search results, comprising a first ranking of the first search result and a second ranking of the second search result, wherein determining the summary scores of the plurality of summaries comprises determining a first summary score of the first summary based upon the first ranking.

9. The method of claim 1, comprising:
determining a similarity score associated with a similarity between at least a portion of the first summary and content associated with an internet resource corresponding to the second search result, wherein determining the summary scores of the plurality of summaries comprises determining a first summary score of the first summary based upon the similarity score.

10. The method of claim 1, wherein:
determining a similarity score associated with a similarity between at least a portion of the first summary and content associated with an internet resource corresponding to the first search result, wherein determining the summary scores of the plurality of summaries comprises determining a first summary score of the first summary based upon the similarity score.

11. A non-transitory machine-readable medium having stored thereon processor-executable instructions that when executed cause performance of operations, the operations comprising:
receiving, from a client device, a query;
in response to the query, generating a plurality of search results corresponding to a plurality of internet resources associated with the query;
generating, using a first content extraction model, a first content item based upon a first search result of the plurality of search results;
generating, using a second content extraction model, a second content item based upon the first search result;
generating, using the first content extraction model, a third content item based upon a second search result of the plurality of search results;
generating, using the second content extraction model, a fourth content item based upon the second search result;
generating, using a language model, a plurality of summaries comprising:
a first summary of the first content item;
a second summary of the second content item;
a third summary of the third content item; and
a fourth summary of the fourth content item;
determining summary scores of the plurality of summaries;
selecting the first summary from the plurality of summaries based upon the summary scores; and
in response to selecting the first summary, providing the first summary for display on the client device.

12. The non-transitory machine-readable medium of claim 11, the operations comprising:
displaying a search interface on the client device, wherein the query is received via the search interface; and
in response to selecting the first summary, displaying the first summary via the search interface concurrently with displaying one or more representations of one or more search results of the plurality of search results via the search interface.

13. The non-transitory machine-readable medium of claim 11, wherein generating the plurality of summaries comprises:
generating, using the language model, an initial summary comprising a plurality of summary items;
determining, based upon the plurality of summary items and the query, a plurality of relevance statuses comprising:
a first relevance status of a first summary item of the plurality of summary items, wherein the first relevance status indicates that the first summary item is relevant to the query; and
a second relevance status of a second summary item of the plurality of summary items, wherein the second relevance status indicates that the second summary item is not relevant to the query; and
generating the first summary based upon the initial summary and the plurality of relevance statuses.

14. The non-transitory machine-readable medium of claim 13, wherein generating the first summary comprises:
including the first summary item in the first summary based upon the first relevance status indicating that the first summary item is relevant to the query; and
not including the second summary item in the first summary based upon the second relevance status indicating that the second summary item is not relevant to the query.

15. The non-transitory machine-readable medium of claim 13, wherein determining the summary scores of the plurality of summaries comprises:
determining a first summary score of the first summary based upon the plurality of relevance statuses.

16. The non-transitory machine-readable medium of claim 13, wherein determining the summary scores of the plurality of summaries comprises:
determining a first summary score of the first summary based upon a quantity of summary items of the plurality of summary items.

17. The non-transitory machine-readable medium of claim 13, wherein determining the summary scores of the plurality of summaries comprises:
determining a first summary score of the first summary based upon item sizes of the plurality of summary items.

18. The non-transitory machine-readable medium of claim 11, comprising:
determining rankings, of the plurality of search results, comprising a first ranking of the first search result and a second ranking of the second search result, wherein determining the summary scores of the plurality of summaries comprises determining a first summary score of the first summary based upon the first ranking.

19. A computing device comprising:
a processor; and
memory comprising processor-executable instructions that when executed by the processor cause performance of operations, the operations comprising:
receiving, from a client device, a query;
in response to the query, generating a plurality of search results corresponding to a plurality of internet resources associated with the query;
generating, using a first content extraction model, a first content item based upon a first search result of the plurality of search results;
generating, using a second content extraction model, a second content item based upon the first search result;
generating, using the first content extraction model, a third content item based upon a second search result of the plurality of search results;
generating, using the second content extraction model, a fourth content item based upon the second search result;
generating, using a language model, a plurality of summaries comprising:
a first summary of the first content item;
a second summary of the second content item;
a third summary of the third content item; and
a fourth summary of the fourth content item;
determining summary scores of the plurality of summaries;
selecting the first summary from the plurality of summaries based upon the summary scores; and
in response to selecting the first summary, providing the first summary for display on the client device.

20. The computing device of claim 19, the operations comprising:
displaying a search interface on the client device, wherein the query is received via the search interface; and
in response to selecting the first summary, displaying the first summary via the search interface concurrently with displaying one or more representations of one or more search results of the plurality of search results via the search interface.
